(19) United States
(12) Patent Application Publication
(10) Pub. No.: US 2006/0281497 A1
(43) Pub. Date: Dec. 14, 2006

(54) Color variation display method of mobile phone

(75) Inventors: Cheng-Shing Lai, Taipei (TW); Feng-Bo Xie, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/137,477

(22) Filed: May 26, 2005

(51) Int. Cl. H04B 1/38; H04M 1/00

(52) U.S. Cl. 455/566

(57) ABSTRACT

The present invention is to provide a color variation display method of mobile phone having a thermo sensor and a thermo module therein, wherein the thermo sensor is used to detect environment temperature outside the mobile phone, and the thermo module is used to analyze and compare the detected environment temperature with preset data stored in the mobile phone, allowing the mobile phone to display colors and pictures on the display screen according to the environment temperature variation automatically.

### BACKGROUND OF THE INVENTION

I. Field of the Invention

This invention relates generally to a color display of mobile phone, and more specifically to a color variation display method of mobile phone that changes the color of the color display of mobile phone according to temperature variation by utilizing a thermo sensor and a thermo module installed therein, where the thermo sensor is used to detect the environment temperature variation, and the thermo module is then used to analyze the detected temperature data and compare the detected temperature data with the preset data stored in the mobile phone.

II. Description of the Prior Art

Heretofore, it is known that communication and network technologies advance rapidly, mobile phones become very popular for their small physical size, powerful functions and lowering cost, mobile phone communication becomes one of the most popular communication methods. Users can talk to friends or business partners instantly for information exchange, mobile phone offers simpler, more convenient and more rapid advantages than traditional phone.

In addition, people's working and life paces are much faster and need instant response in the present world, mobile phones not only can be a rapid communication tool but also offer many other software, such as games, phone book, voice mail, alarm clock . . . etc, other extra services for more application can fulfill users' requirements with only one single mobile phone.

Generally speaking, along with mobile phone advancing technology, people pay more attention to color screen mobile phones; if color screen mobile phones started in 2002, then 2003 was the time for color screen mobile phones to be popular. Two years ago color screen mobile phones stood for new fashion, the bright colors attracted people's attention along with major manufacturers rolled out new models continuously, now color screen mobile phones almost replace mono screen mobile phones and become fashionable communication tool and major market trend.

Nowadays major manufacturers focus on two markets, one is the high price and high end color screen mobile phone market, the other one is lower cost and low end color screen mobile phone market. In the high end market, manufacturers compete with advanced technology and powerful functions. In the low end market, manufacturers compete with applicable function and reasonable price/performance ratio. To color screen mobile phones, the display effect is the most concern parameter. Now 65k true color screen mobile phones become new products' major configuration trend.

Along with coming 3G network era and the appearance of the intelligent mobile phones, users can work and watch movie with mobile phones, this is also a symbol of high tech, major mobile phone manufacturers emphasize their manufacturing capability on color screen mobile phones.

Even though the display screen of color screen mobile phone is color, however once set, the color cannot be changed; even if the color can be adjusted, then it must be done manually, however the display manner is limited, users still have to face the same color and display and feel bored, such cannot fulfill consumers' desire.

If manufacturers can design a product that solves defects described above and shows special characters of each mobile phone, such product will be appreciated by consumers; at the same time if manufacturers offer color screen mobile phones with special characters, consumers also can have multiple choices, such products should have much more competition among similar color screen mobile phones.

### SUMMARY OF THE INVENTION

Based on the above in depth introduction, we can realize that current color screen mobile phones have several disadvantages, such as the color of color display screen cannot be changed, and have to be adjusted manually, users cannot set the changes of colors . . . etc.

It is therefore a primary object of the invention to provide a color variation display method of mobile phone that is to have a thermo sensor and a thermo module installed inside a mobile phone, the thermo sensor detects the environment temperature variation to realize the automatic color change of the display screen of the mobile phone. Therefore, when color variation function is activated, the thermo module is also activated, the thermo sensor detects and records current temperature when the environment temperature changes, and the thermo module analyzes the detected temperature data and compares the recognizable data with the preset data stored in the mobile phone, if the data collected are within the range of preset values, the mobile phone displays the corresponding display conditions on the display screen.

It is still an object for the invention to provide a color variation display method of mobile phone in which a thermo sensor and a thermo module inside a mobile phone, the design has the advantage to allow the display screen changes colors and pictures at the will of user, and automatically changes colors and pictures according to environment temperature variation without manual adjust, the colors and pictures variation can be set by users to make the mobile phones more user personality.

The accomplishment of the above-mentioned object of the present invention will become apparent from the following description and its accompanying drawings which disclose illustrative an embodiment of the present invention, and are as follows:

### BRIEF DESCRIPTION OF THE DRAWINGS

FIG. 1 is the block diagram of the present invention;

FIG. 2 is the flow chart of the present invention.

### DESCRIPTION OF THE PREFERRED EMBODIMENT

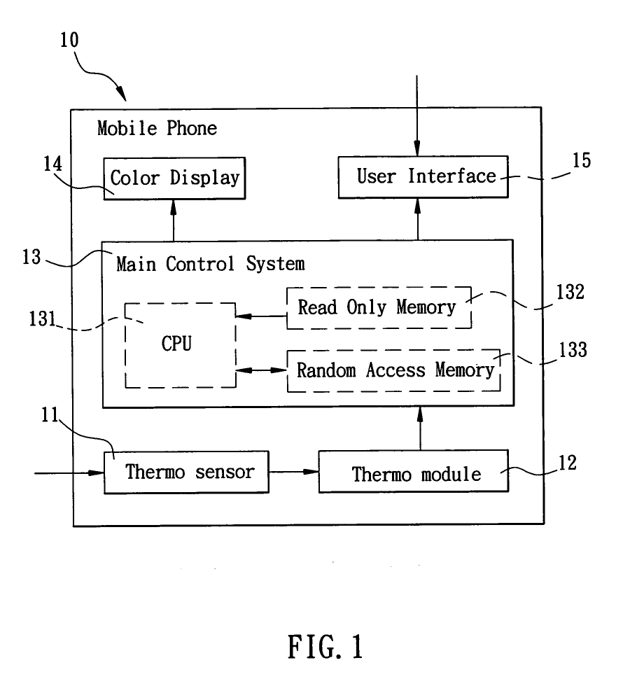

Referring to FIG. 1, the present invention comprises a thermo sensor 11 and a thermo module 12 inside a mobile phone 10, the thermo sensor 11 collects and transmits outside temperature data to the thermo module 12, the thermo module 12 converts and transmits these data into recognizable format for a main control system 13 in the mobile phone 10, the recognizable data are compared with the previously stored data inside the mobile phone 10, then the mobile phone system runs the matched routine for corresponding display screen data, the display screen 14 of the mobile phone 10 displays corresponding colors or pictures accordingly. Thus, the display screen 14 of the mobile phone 10 displays different colors or pictures along with the variation of temperature.

Referring to FIG. 1, the main control system 13 is built inside the mobile phone 10 to control the mobile phone 10 of the present invention, the main control system 13 comprises a CPU 131, a ROM 132 (Read Only Memory), a RAM 133 (Random Access Memory), a communication circuitry (not shown in FIG), a graphic control circuitry (not shown in FIG) and the corresponding software (not shown in FIG); the CPU 131 does arithmetic, logic operations and gives instructions to send the data to the right components after calculation; the ROM 132 stores routines with special functions and system program, the RAM 133 is controlled by CPU 131 and is the main storage area of the mobile phone 10 to store conditional instructions and preset data; the communication circuitry comprises all the communication components of the mobile phone 10 to execute communication functions; the graphic control circuitry processes graphic functions; the display screen 14 (LCD) is the display of the mobile phone 10 and displays corresponding colors and pictures according to the conditional instructions.

Referring to FIG. 1, the mobile phone 10 of the present invention also includes an UI (User Interface) to communicate with users; the UI consists of an output unit (such as display screen 14, LED's) and an input unit (such as keypads, touch display screen 14 or touch pen (not shown in FIG)).

Based on the above description, the thermo sensor 11 built inside the mobile phone 10 detects environment temperature and transmits the data to the temperature sensor 12 as the original data to be analyzed, at the same time, the temperature sensor 12 compares the data collected with the preset data stored in the mobile phone 10; if the collected data is within a certain range, the corresponding display screen instructions is called for the display screen 14; when the display screen 14 receives the display conditional instructions, the display screen 14 then displays colors and pictures accordingly.

When the temperature changes, the thermo sensor 11 activates the thermo module 12, the mobile phone 10 compares the data and displays the corresponding display conditions on the display screen 14 according to the temperature range to which the current temperature is associated:

| Temperature Range | Display screen 14 color |
|---|---|
| −30˜0 | White |
| 0˜10 | Gray white |
| 10˜20 | Green |
| 20˜30 | Blue |
| 30˜50 | Yellow |

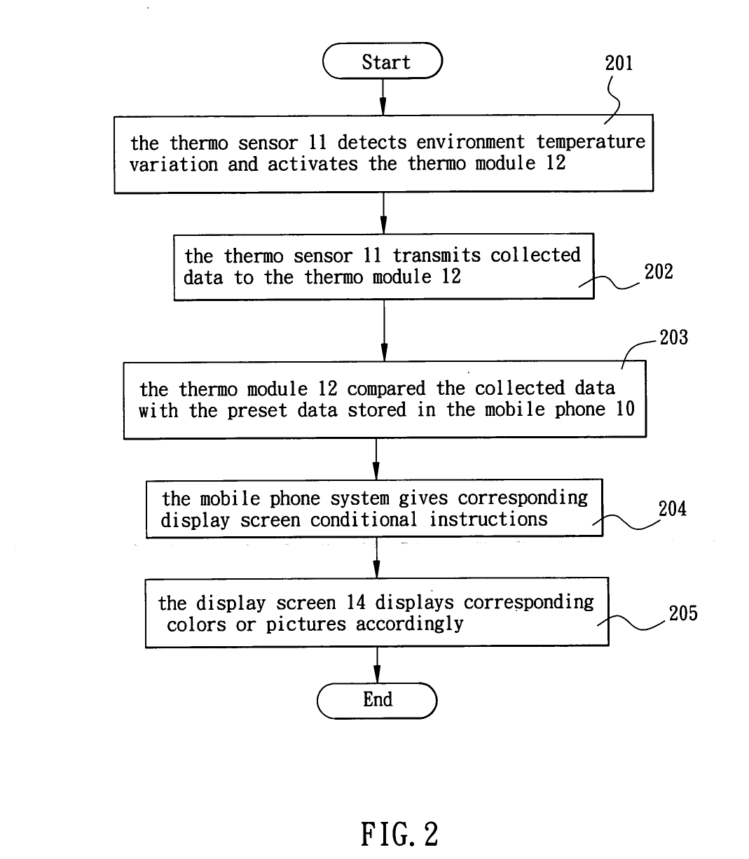

The following description explains the process of color variation of the display screen 14 of the present invention, when the color variation function of the display screen 14 of the mobile phone 14 is activated, the mobile phone 14 proceeds with the procedure including the following steps, as referring to FIG. 2:

Step 201: the thermo sensor 11 detects environment temperature variation and activates the thermo module 12;

Step 202: the thermo sensor 11 transmits collected data to the thermo module 12;

Step 203: the thermo module 12 compared the collected data with the preset data stored in the mobile phone 10;

Step 204: the mobile phone system runs the matched routine for corresponding display screen conditional instructions;

Step 205: the display screen 14 of the mobile phone 10 displays corresponding colors or pictures accordingly and ends the procedure.

The display conditions of the display screen 14 are preset by the main control system 13 or by users.

While a preferred embodiment of the invention has been shown and described in detail, it will be readily understood and appreciated that numerous omissions, changes and additions may be made without departing from the spirit and scope of the invention.

FIG. 1

10 Mobile Phone

11 Thermo sensor

12 Thermo module

13 Main Control System

14 Color Display

15 UI (User Interface)

131 CPU

132 ROM (Read Only Memory)

133 RAM (Random Access Memory)

FIG. 2

Start

Procedure 201: the thermo sensor 11 detects environment temperature variation and activates the thermo module 12.

Procedure 202: the thermo sensor 11 transmits collected data to the thermo module 12.

Procedure 203: the thermo module 12 compared the collected data with the preset data stored in the mobile phone 10.

Procedure 204: the mobile phone system gives corresponding display screen conditional instructions.

Procedure 205: the display screen 14 displays corresponding colors or pictures accordingly.

End

What is claimed is:

1. A color variation display method enabling a mobile phone to proceed with process comprising the steps of:
collecting environmental temperature data outside said mobile phone;
converting said environmental temperature data into a recognizable format;
comparing said environmental temperature data in said recognizable format with preset data stored in said mobile phone;
reading display screen data stored in said mobile phone corresponding to said preset data; and
displaying colors or pictures corresponding to said display screen data on a display screen of said mobile phone along with variation of said environmental temperature data.

2. A color variation display system in a mobile phone, comprising:
a thermo sensor collecting environmental temperature data;
a thermo module receiving said environmental temperature data detected by said thermo sensor and converting said environmental temperature data into a recognizable format;
memory means for storing preset data and display screen data corresponding thereto, and
a CPU comparing said environmental temperature data in said recognizable format with said preset data and displaying colors or pictures corresponding to said display screen data on a display screen of said mobile phone along with variation of said environmental temperature data.

3. The color variation display system in a mobile phone recited in claim 2, wherein said mobile phone includes an UI to communicate with users, said UI consists of an output unit and an input unit.

4. The color variation display system in a mobile phone recited in claim 2, wherein said thermo sensor activates said thermo module when the temperature changes, said mobile phone compares said outside temperature data with said preset data stored in said mobile phone and displays colors or pictures corresponding to said preset data on said display screen.

5. The color variation display system in a mobile phone recited in claim 4, wherein said colors or pictures are preset by said mobile phone or by users.

6. The color variation display system in a mobile phone recited in claim 3, wherein said output unit are display screen and LED's.

7. The color variation display system in a mobile phone recited in claim 3, wherein said input unit are keypads, touch display screen or touch pen.
